(19) United States
(12) Patent Application Publication
(10) Pub. No.: US 2021/0133340 A1
(43) Pub. Date: May 6, 2021

(54) System and Method for Protecting Information

(71) Applicant: Gad SOLOTOREVSKY, Even Yehuda (IL)

(72) Inventor: Gad SOLOTOREVSKY, Even Yehuda (IL)

(21) Appl. No.: 16/674,548

(22) Filed: Nov. 5, 2019

(51) Int. Cl. G06F 21/62; G06F 21/44; G06F 21/71

(52) U.S. Cl. CPC G06F 21/6218; G06F 21/71; G06F 21/44

(57) ABSTRACT

A system and a method are provided for storing received data in a protected mode in a data repository. The system is characterized in that it is configured to prevent interpretation of the protected data in a case where an interpretation map and/or the ids mapping table associated with the protected data has been compromised, by changing mode of protection of said protected data, and wherein the change of protection mode of the protected data is affected either a) upon detecting that said interpretation map and/or an ids mapping table has been compromised, or b) on a periodical basis, or c) any combination thereof.

### TECHNICAL FIELD

The present disclosure relates in general to improved systems and methods for securing data. More particularly, the present disclosure relates to providing protection to data when current protection provided to that data is being breached.

### BACKGROUND

Vast amount of sensitive data, such as credit card numbers, health records, password lists, are stored in digital pools, referred to as the “cloud storage” and in proprietary data centers. There are various ways to store sensitive data, to name but few, file systems, distributed file systems, databases, and the like. However, this sensitive information is exposed to everybody who has read access permissions to the data repository, be it either legitimate permissions due to the person's responsibility, for example, a data base administrator, or permissions obtained illegally, for example by a hacker.

Sensitive data is often protected in one of different ways, among which are encryption, hashing, and any combinations thereof.

To get a meaningful information that relates to the stored protected data, it is not enough to be able to read that data, but there is also a need to be able to restore it back to its original state. For example, if data was encrypted by applying asymmetric cryptographic, one would typically require the encryption private key to restore that data. If hashed data were stored, the hashing table is usually required to restore or interpret the data.

Now, when security breaches occur, they might lead to situations wherein an attacker or a hacker, is able to gain access to the information required to restore the protected data, such as the private encryption key, or the hashing table, as the case may be.

When the information required to interpret the protected data is compromised, there is a risk that the protected data itself will also be compromised. Therefore, there is still a need to secure the protected data and ensure that even if a person obtains the information required to interpret the protected data, still, that person will not be able to apply this information for interpreting the protected data.

Solutions that rely on straightforward methods such as encrypting the whole stored data for a second time by using a new encryption key, or implementing an additional, different encryption method, are problematic for various reasons. To name but few, the volumes of the protected data could be too immense to enable practical second encryption, there could be many backups of the protected data which are stored elsewhere, there are many processes and systems that require using the protected data, in order to be able to execute these processes they will have to be modified in order to enable the process to encrypt the data in a new way that will be compatible with the second encryption, hence this solution might be too long, costly, cause significant downtime of the system, and is prone to generate malfunctions.

Therefore, there is a need for a solution that overcomes the above problems.

### SUMMARY OF THE DISCLOSURE

The disclosure may be summarized by referring to the appended claims.

It is an object of the present disclosure to provide a novel system and a method for storing received data in a protected mode in a data repository.

It is another object of the present disclosure to provide a novel system and a method for preventing undesired interpretation of data being in a protected mode.

It is still another object of the present disclosure to provide a novel system and a method for changing mode of protection of the protected data upon detecting a breach in the system.

Other objects of the present disclosure will become apparent from the following description.

According to a first embodiment of the present disclosure, there is provided a system for storing received data in a protected mode in a data repository, wherein said system is characterized in that it is configured to prevent interpretation of the protected data in a case where an interpretation map and/or said ids mapping table associated with said protected data is compromised, by changing mode of protection of said protected data, and wherein the change of protection mode of the protected data is affected either a) upon detecting that said interpretation map and/or an ids mapping table has been compromised (e.g. breached), or b) on a periodical basis, or c) any combination thereof.

The term “protected data” as will be used herein throughout the specification and claims is used to denote data that has been transformed from its original form to another form thereof, by using any method that is known in the art per se, such as for example hashing, encryption, any combinations thereof, and the like.

The terms “interpreting” and “interpretation” when relates to protected data as will be used interchangeably herein throughout the specification and claims, is used to denote a process of restoring the protected data to its original form.

The term “interpretation map” as will be used herein throughout the specification and claims, is used to denote information required to interpret protected data. For example, if data is protected by using a hashing algorithm, the interpretation map will be a respective hashing table, whereas if data is protected by using a public key encryption algorithm, then the interpretation map will be the respective private key.

The term “ids mapping table” as will be used herein throughout the specification and claims, is used to denote information required to carry out a mapping process of protected data to respective one or more identifiers, and/or to carry out de-mapping of one or more identifiers to respective protected data.

In accordance with another embodiment, the system comprising:
at least one processor configured to:
   receive data to be protected and apply a first protecting scheme thereon, thereby converting the received data to a protected data;
   map the protected data into one or more identifiers; and
   initiate a change of said first protecting scheme to a second protecting scheme either a) upon detecting that either said interpretation map and/or said ids mapping table has been compromised, or b) on a periodical basis, or c) any combination thereof, by converting the protected data into the originally received data and applying said second protecting scheme onto said originally received data to obtain a newly protected data;
   map the newly protected data into one or more identifiers;
at least one storage configured to:
   store information that relates to mapping of the protected data into the one or more identifiers; and
   store the one or more identifiers.

According to still another embodiment, the at least one processor is further configured to map values associated with the first protecting scheme into values associated with the second protecting scheme.

By yet another embodiment, the system is a distributed system comprising a plurality of processors, wherein at least two of the plurality of processors are located at different geographical locations.

In accordance with still another embodiment, the system comprises a plurality of storages, wherein at least two of the plurality of storages are located at different geographical locations.

According to still another embodiment, the data repository comprises both data received in its original form and data received in its protected mode.

According to another aspect of the present disclosure there is provided a method for storing protected data in a data repository, wherein the method is characterized in that it is configured to prevent interpretation of the protected data in case an interpretation map associated with the protected data is compromised, by changing a mode of protection of said protected data, and wherein the change of protection mode of the protected data is affected either upon a) detecting that said interpretation map and/or an ids mapping table has been compromised, or b) on a periodical basis, or c) any combination thereof.

By yet another embodiment of this aspect of the disclosure, the method comprises the steps of:

providing data to be protected and applying a first protecting scheme on at least part of the received, thereby converting the at least part of the received data to a protected data;

mapping the protected data into one or more identifiers;

generating an interpretation map which comprises information required to interpret protected data;

generating an ids mapping table which comprises information required to carry out a mapping process of protected data to the respective one or more identifiers, and/or to carry out de-mapping process of the one or more identifiers to respective protected data;

storing the interpretation map the said ids mapping table;

initiating a change of said first protecting scheme with a second protecting scheme, either a) upon detecting that either said interpretation map and/or said ids mapping table has been compromised, or b) on a periodical basis, or c) any combination thereof, by converting the protected data being in its first protected scheme into the originally received data, and applying said second protecting scheme onto said originally received data to obtain a newly protected data;

mapping the newly protected data into one or more identifiers;

storing the one or more identifiers associated with the newly protected data.

By yet another embodiment of this aspect, the method further comprising a step of mapping values associated with the first protecting scheme into values associated with the second protecting scheme.

### BRIEF DESCRIPTION OF TRE DRAWINGS

The accompanying drawings, which are incorporated herein and constitute a part of this specification, illustrate several embodiments of the disclosure and, together with the description, serve to explain the principles of the embodiments disclosed herein.

FIG. 1—illustrates an example of a sub-system construed in accordance with an embodiment of present invention;

FIG. 2.—exemplifies a block diagram of a sub-system construed in accordance with another embodiment of the present invention;

FIG. 3—demonstrates another embodiment of the present invention, presenting a data generator operative to provide data to a system at which it is comprised;

FIG. 4—illustrates still another embodiment of the present invention, presenting a data customer module operative to request and customer data from the system; and

FIG. 5—exemplifies a method of carrying out an embodiment construed in accordance with the present disclosure.

### DETAILED DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention.

In order to simplify the following description for the reader, the invention will be described hereinafter as if the data protection method applied is a hashing function. Obviously, as should be clear to any person of the art, other methods for implementing data protection that are known in the art per se are also applicable, and should be regarded as being encompassed by the present invention.

The present invention provides a method and a system for storing protected data in a data repository, and providing an efficient method to prevent interpretation of the protected data in case the interpretation map associated with that protected data, has been compromised.

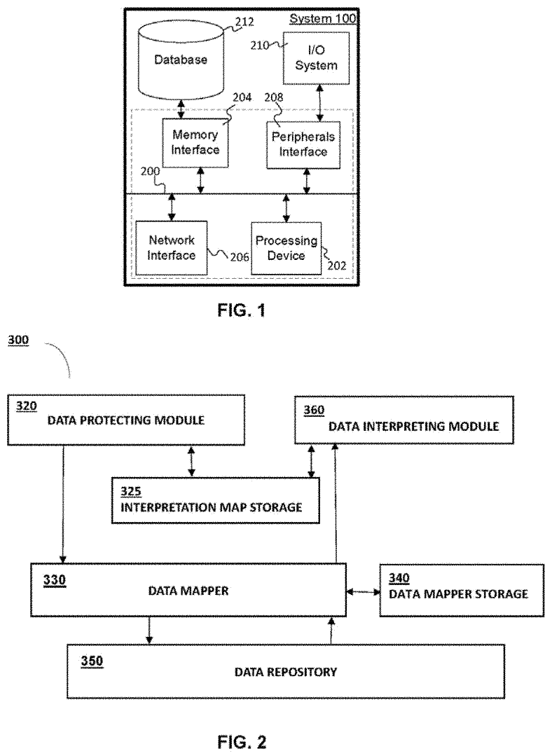

FIG. 1 is a block diagram of an example of components of sub-system 100. A system construed in accordance with the present disclosure, aims to enable prevention of interpretation of protected data.

In one embodiment, the system may include a bus 200 (or other communication mechanism) that interconnects subsystems and components for transferring information within sub-system 100. For example, bus 200 may interconnect a processing device 202, a memory interface 204, a network interface 206, and a peripherals interface 208 connected to I/O system 210. Processing device 202, shown in FIG. 1, may include at least one processor configured to execute computer programs, applications, methods, processes, or other software to perform embodiments described in the present disclosure.

The term “processing device” refers to any physical device having an electric circuit that performs a logic operation. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™ or by AMD™. The processing device may include a single core or multiple core processors executing parallel processes simultaneously. In one example, the processing device may be a single core processor configured with virtual processing technologies. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, sub-system 100 may use memory interface 204 to access memory device 212. Memory device 212 may include high-speed random access memory and/or non-volatile memory such as one or more magnetic disk storage devices, one or more optical storage devices, and/or flash memory (e.g., NAND, NOR). Memory device 212 may store an operating system, such as LINUX, iOS, UNIX, OS X, WINDOWS, or an embedded operating system such as VXWorkS. The operating system can include instructions for handling basic system services and for performing hardware dependent tasks. In some implementations, the operating system can be a kernel (e.g., UNIX kernel).

As used herein, a non-transitory computer-readable storage medium refers to any type of physical memory on which information or data readable by at least one processor can be stored.

Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within sub-system 100, or at a remote location. Additionally, one or more computer-readable storage mediums can be utilized in implementing a computer-implemented method. The term “computer-readable storage medium” should be understood to include tangible items and exclude carrier waves and transient signals.

In some embodiment, sub-system 100 may include network interface 206 coupled to bus 200 that is configured to provide a two-way data communication to a communications network. In one embodiment, network interface 206 may include an asymmetric digital subscriber line (ADSL) card, cable modem, or a satellite modem. As another example, network interface 206 may include a local area network (LAN) card to provide a data communication connection to a compatible LAN. In another embodiment, network interface 206 may include an Ethernet port connected to radio frequency receivers and transmitters and/or optical (e.g., infrared) receivers and transmitters. The specific design and implementation of network interface 206 depends on the communications network(s) over which sub-system 100 is intended to operate. For example, in some embodiments, capturing device 105 may include network interface 206 designed to operate over a GSM network, a GPRS network, an EDGE network, a Wi-Fi or WiMax network, and a Bluetooth® network. In any such implementation, network interface 206 may be configured to send and receive electrical, electromagnetic or optical signals that carry digital data streams representing various types of information.

Sub-system 100 may also include peripherals interface 208 coupled to bus 200. Peripherals interface 208 may be connected to devices and subsystems to facilitate multiple functionalities, such as for example printing the outcome obtained by executing the algorithm disclosed herein for a given individual. In one embodiment, peripherals interface 208 may be connected to I/O system 210 configured to receive signals or input from devices and providing signals or output to one or more devices that allow data to be received and/or transmitted by sub-system 100 (e.g. retrieving data to be used while executing the algorithm disclosed herein). In one example, I/O system 210 may include a touch screen controller, an audio controller, and/or other input controller(s). The touch screen controller may be coupled to a touch screen and can, for example, detect contact, movement or break thereof using any of a plurality of touch sensitivity technologies, including but not limited to capacitive, resistive and infrared technologies as well as other proximity sensor arrays or other elements for determining one or more points of contact with the touch screen. In addition, I/O system 210 may include a display screen (e.g., CRT or LCD) in place of the touch screen. The audio controller may be coupled to a microphone and a speaker to facilitate voice-enabled functions, such as voice recognition, voice replication, digital recording, and telephony functions.

FIG. 2 presents a block diagram, illustrating main components of a sub-system 300 construed in accordance with an embodiment of the present invention. Block 320, is a data protecting module which is configured to receive data and transforms/converts the received data into protected data by implementing, according the present example, a hashing technique.

Let us now assume for example that the original received data that needs to be protected is the string “12345”, and the protecting method is a RIPE Message Digest 128-bit hash function. Once the protecting method has been applied on the original data, the combination “802338594db79b21dafa9739ea9de3d6” becomes the protected data.

In different embodiments of the disclosure, different data formats and markup languages may be used for forwarding the received data to the data protecting module 320. These may include, but not limited to, strings, coma separated values (CSV), JavaScript Object Notation (JSON), Extensible Markup Language (XML), Hypertext Markup Language (HTML), data streaming, binary data, stings representing SQL queries, and the like.

Moreover, the data protecting module may be configured to receive instructions or indicators that may point out which part(s) of the data should be protected and which should not.

The indicators may be provided by using any one of different applicable methods such as by using special tags in a markup language, using predefined character sequences to denote the beginning and the end of the data to be protected, etc. The data protecting module may apply either the same indicators or different ones in order to mark which is the part of the data that was protected.

For example, the combination “<$$<” may be used to indicate the start of the data to be protected, and “>$$>” to indicate its end. The data protecting module may use the combination “<#<” to indicate the start of the data that was protected, and “>#>” to indicate its end. If the data protecting module is given the string “<$$<12345>$$>Hello world<$$<12345>$$>”, and RIPE Message Digest 128-bit hash function is used for implementing the protection, then the resulting string will be “<$#$<802338594db79b21dafa9739ea9de3d6>$#$>Hello world<$#$<802338594db79b21dafa9739ea9de3d6>$#$>”.

Data protecting module 320 is also configured to create an interpretation map if none exists, or use an existing interpretation map, wherein the interpretation map is used to associate the original string 12345 with the resulting string, namely, 802338594db79b21dafa9739ea9de3d6.

According to one option, the data protecting module may further comprise a data storage, block 325, configured to store the information associated with the interpretation map. The data storage may be comprised as a part of the data protecting module itself, or an external data storage may be used, such as for example a database, a file system, or a distributed file system.

Also, according to one option the data protecting module can be implemented as a standalone component that is configured to receive requests for data protecting, whereas according to another option the data protecting module may be implemented as a group of distributed components, where each is configured to receive requests for data protecting. Alternatively, the data protecting module may be embedded as a function or component in an appropriate software or hardware.

Data mapper, 330, is configured to map the protected data into unique identifiers, where no two different protected data elements are mapped to a single identifier. The data mapper may also perform a reverse mapping from the identifiers to the protected data (i.e. de-mapping). Let us assume for example, that the data mapper has mapped the string “8d969eef6ecad3c29a3a629280e686c” to identifier No. 1 and string “9b17d0f7d22b456f121257dc1254e” to identifier No. 2. The data mapper may also be used to de-map identifier No. 1 in order to retrieve string 8d969eef6ecad3c29a3a629280e686c, and retrieve from identifier No. 2 the string “9b17d0f7d22b456f121257dc1254e”.

The mapping identifiers uniqueness should be guaranteed on a per case basis of a data protecting implementation, yet it does not have to be universally unique. For example, in one implementation a string, say, “8d969eef6ecad3c29a3a629280e686c” could be mapped to identifier No. 1 while in another implementation, another string, say, “9b17d0f7d22b456f121257dc1254e” could be mapped to identifier No. 1.

According to another embodiment, only data that was protected by data protecting module 320 will be mapped by the data mapper, whereas the rest of the data will remain intact.

Different methods may be used to map the protected data into unique identifiers, among which data bases sequences, generation of universally unique identifiers (UUID) using different algorithms, applying hashing functions with collision resolution to the data, and the like.

In addition, data mapper 330 may be implemented as a standalone component that receives requests for data mapping to unique identifiers, or to de-map identifiers into protected data. Alternatively, data mapper 330 can be implemented as a group distributed components, each configured to receive requests to map protected data to unique identifiers or de-map identifiers to the protected data. By yet another option, the data mapper may be embedded as a function or component in a respective software or hardware. The details of the data mapper implementation option will typically vary, depending on the method used for the mapping process (e.g. data base sequence, UUID generation algorithm, hashing with collision resolution), and the architecture used (e.g. a single component, distributed components, embedded in software or hardware components). Yet, it should be obvious to those skilled in the art that other methods and/or architectures that are known in the art per se may also be implemented, without departing from the scope encompassed by the present invention.

Another optional block illustrated in FIG. 2 is data storage (block 340), that is configured to store ids mapping table information that enables mapping of protected data to identifiers and/or de-mapping identifiers to their respective protected data. This data storage 340 can be part of the data mapper 330 itself, or an external data storage, such as a database, file system, or distributed file system.

Block 350, data repository, is a data storage which is configured to store both unprotected data and the identifiers to which protected data was mapped.

The data repository may be implemented by using any applicable technology known in the art per se, such as a relational database, a non-relational database, a file system, a Hadoop Distributed file system (HDFS), or any combination thereof.

Optionally, data mapper 330 is not configured to access directly data repository 350, and an intermediate layer, such as a web server, a queuing mechanism, is used to access the data repository.

Block 360 is a data interpreting module, which is configured to receive protected data and to perform an appropriate process thereon in order to interpret the protected data by using the information that has been stored by the data protecting module in an interpretation map storage, block 325. This process is in fact the reverse process of the one carried out by block 320, the data protecting module. For example, if the data protecting is configured to use RIPE Message Digest 128-bit hash function, to protect original string “12345” as “802338594db79b21dafa9739ea9de3d6” and has stored this information in the interpretation map storage, then block 350 will be able to de-map string “802338594db79b21dafa9739ea9de3d6” back to the original string 12345*.

Moreover, data interpreting module is preferably configured to receive instructions and/or indicators that relate to which part of the data should be interpreted, and which should not.

As already described above, the indicators may be provided by using any one of different applicable methods such as by using special tags in a markup language, using predefined character sequences to denote the beginning and the end of the data to be protected, etc. The data protecting module may apply either the same indicators or different ones in order to mark which is the part of the data that should be protected by the data mapper.

In some embodiments of the present disclosure, data interpreting block 360 may be implemented as a standalone component that receives requests to interpret data, whereas in other embodiments data interpreting block 360 may be implemented as a plurality of distributed components each receiving requests to interpret data. Alternatively, data interpreting block 360 be embedded as a function or as a component in a software or hardware. Alternatively, the following entities (or part thereof), namely, data protecting module, 320, data mapper, 330, and data interpreting module, 360, can be used as part of, or as an “add-on” to a web browser, and/or to a reporting or data analysis system, and/or to an e-commerce system, etc.

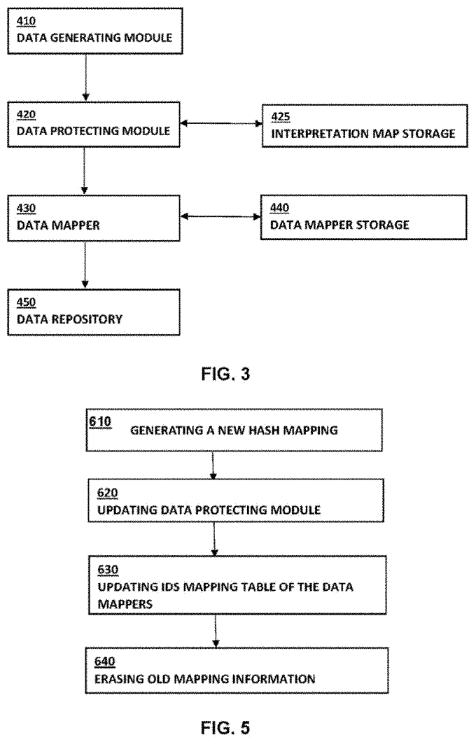

FIG. 3 illustrates a sub-system 400 that comprises data generating module 410 that is configured to enable submitting data to the overall system.

Data generating module 410 is configured to generate data that will be stored in the system. By one example, let us assume that the data repository is an SQL data base, and the data generating module 410 is required to enable storing credit card data of two users, where each data set includes four fields, namely, customer name, credit card number, credit card expiration date, and credit card color. In such an example, data repository 450, comprises a table named creditcards that includes four fields: customerName, ccNumber, ccExpdate, ccColor.

Now, let us assume that the data associated with the first customer is: John Doe, 1111 1111 1111 111, 02/2020, blue, and the data associated with the second customer is: Jane Doe, 2222 2222 2222 222, 02/20, purple.

In this example, the data protecting module 420 and the data mapper 430 may use a string for forwarding the above information and may use delimiters @@@ and &&& to indicate sub-strings that should be protected by the data mapper. Let us assume that the data generating module 410 is required to protect the information that relates to the customer name, the credit card number, and the credit card expiration date, while keeping the credit card color unprotected.

In this example, the data generating module 410, may generate a string representing an SQL query:

INSERT INTO creditcards (customerName, ccNumber, ccExpdate, ccColor.) VALUES

(@@@John Doe&&&, @@@1111 1111 1111 111&&&, @@@02/2020&&&, “blue”),

(@@@Jane Doe&&&, @@@2222 2222 2222 222&&&, @@@02/2020&&&, “purple”)

In this example, block 420, the data protecting module will process the string by replacing each sub string which is required to be protected, with its own hash code, using the RIPE Message Digest 128-bit hash function.

The resulting string will be

“INSERT INTO creditcards (customerName, ccNumber, ccExpdate, ccColor)

### VALUES

(@@@140ec146d14842588a1ee83e14113e66&&&, @@@e65de229fa01a8a72e144c2010a8db46&&&, @@@3092575f6d97570b82a5832d8545be4a&&&, “blue”),
(@@@1b04848e5076377f6d65498caf91bd5b&&&, @@@84791b4ecfd07fece21d5126b7eabf5b&&&, @@@3092575f6d97570b82a5832d8545be4a&&&, “purple”)”.

This string will be forwarded to block 430, the data mapper, which in turn will map each protected string to a unique identifier, one that has not been allocated by the data mapper to any other protected data string.

For example, 140ec146d14842588a1ee83e4113e66 will be mapped to 1, e65de229fa01a8a72e144c2010a8db46 to 2, 3092575f6d97570b82a5832d8545be4a to 3, 1b04848e5076377f6d65498caf91bd5b to 4, and 84791b4ecfd07fece21d5126b7eabf5b to 5.

This mapping information will be stored in block 440, the data mapper storage, and the resulting query will be

“INSERT INTO creditcards (customerName, ccNumber, ccExpdate, ccColor)

### VALUES

(1, 2, 3, “blue”),

(4, 5, 3, “purple”)”.

This query will be used to store the required data in the data repository 450.

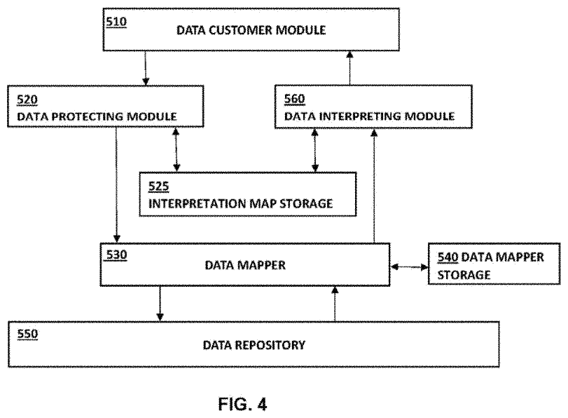

According to another embodiment, the data stored in the data repository includes indications such as delimiters to mark the mapped data, for example delimiters “>&>” and “<&<” to mark the beginning of the data mapped. These delimiters may be used in the process of retrieving the data, (FIG. 4, block 530), in order to identify which part of the data requires de-mapping. In this example, the generated query may be

“INSERT INTO creditcards (customerName, ccNumber, ccExpdate, ccColor)

### VALUES

(“>&>1<&<”, “>&>2<&<”, “>&>3<&<”, “blue”),

(“>&>4<&<”, “>&>5<&<”, “>&>3<&<”, “purple”)”.

Alternatively, the data may be stored in the data repository without any marks indicating which is the mapped data, nor information on which data should be de-mapped and which data should not be de-mapped. The information regarding which data should be de-mapped and which data should not be de-mapped may either be stored at the data mapper, or forwarded as part of the metadata or instructions to the data mapper by the data customer module (block 510 in FIG. 4).

FIG. 4 illustrates a data customer sub-system 500 which is configured to retrieve data from the system. In order to demonstrate the process, we shall use the example provided in FIG. 3. Now, let us assume for example that data customer module 510 requires to retrieve data of credit cards associated with customer “John Doe”. Consequently, data customer module 510 will generate a string representing a query required to retrieve that information, for example

“Select customerName, ccNumber, ccExpdate, ccColor
FROM creditcards
WHERE customerName=@@@John Doe&&&”.

This query will be forwarded to the data protecting module 520, which will apply the same protecting method that was applied by the data protecting module 420, illustrated in FIG. 3, the RIPE Message Digest 128-bit hash function, to map “John Doe” to 140ec146d14842588a1ee83e14113e66, and will forward the following query to the data mapper 540:

“Select customerName, ccNumber, ccExpdate, ccColor
FROM creditcards
WHERE customerName=@@@140ec146d14842588a1ee83e14113e66&&&”

Data mapper 540 will then retrieve information from the mapping table stored in data mapper storage 540 and will map 140ec146d14842588a1ee83e14113e66 to identifier No. 1. The data mapper will then generate the following query:

“Select customerName, ccNumber, ccExpdate, ccColor
FROM creditcards
WHERE customerName=1”

This query will be executed by data repository 550, that will send back to the data mapper 530 the result obtained from executing the query. For example, in the format of a comma delimited record set in which all the identifiers that were determined as a result of this mapping process, will be marked. For example, using the characters sequence $%$

$%$1$%$, $%$2$%$, $%$3$%$, blue

The data mapper will translate back the marked identifiers to the respective protected data and will mark these protected data items as such (i.e. protected data items), for example by using the sequence %$%%:

%$%%140ec146d14842588a1ee83e14113e66%$%%,
%$%% e65de229fa01a8a72e144c2010a8db46%$%%,
%$%%3092575f6d97570b82a5832d8545be4a %$%%, blue,

This string will be forwarded to data interpreting module 560 which is configured to decode the protected data by using information that has been stored in interpretation map storage 525, to:

John Doe, 1111 1111 1111 111, 02/2020, blue, and will forward it to the data customer module 510.

It is to be understood that the example used in FIGS. 3 and 4 demonstrates one possible embodiment. In this embodiment the data repository is a data base, the data generating module and the data customer module forward SQL queries which are used to insert and retrieve data. Obviously, other methods and architectures may be used. For example, the data repository interface may be a REST API, the data generating module and the data customer module will generate strings that will be manipulated and used by the data mapper to generate REST API calls that will store and retrieve data from the data repository. The data generating module and data customer module are examples of clients that may interact with the system described above with relation to FIG. 2.

Additional types of functionalities may be performed by data customer module, such as updating data, deleting data, initiating processes, performing calculations, by interacting with the sub-system 300 described in FIG. 2.

Optionally, the data being forwarded between the data generating module, data protecting module, data mapper, and data repository may also include additional information, such as for example error messages, warnings, performance information, and the like.

In the examples discussed above, the information was forwarded by using strings and characters escape sequences to indicate which part of the data should be protected, mapped, and interpreted. As will be understood by those skilled in the art, other methods, such as ones that implement different ways to achieve the required indications, can be used to indicate which part of the data should be protected, mapped, and interpreted.

As demonstrated in the above examples, both the data generating module and the data customer module are described by using SQL for storing and retrieving the data. In some embodiments, the customers contacting the system, will not forward simply data, for example the string representing the corresponding SQL query, but also meta data, which can in turn be used to indicate what should be done with the data. The meta data may indicate that the data represents an SQL query, but it may also indicate the name of the database, its IP address, the user name and the password associated therewith. Alternatively, the meta data may indicate just that the data represents an SQL query and the name of the database, while the data mapper will have different information that relates to the same customer, for example configuration data regarding the username and the password to be used.

The data mapper, or the intermediate layer, is used to contact the data repository, may carry out additional transformations to the data provided to a layer of abstraction. Thus, if the meta data received by the data mapper indicates for example that the data is an SQL query aimed to a PostgreSQL DB Server which then may add information, such as quotation marks to provide the identifiers associated with the query.

In some embodiments different methods may be used to forward information and requests between the different components, such as remote procedures calls (RPC), rest APIs, message queues, one data customer may use a REST API to pass information from a data protecting module, while another data customer module may use a message queue to request the information from the data protecting module, while the data protecting module may use a remote procedure call to forward the request to the data mapper.

FIG. 5 exemplifies a process of changing the data protecting method applied by the data protecting module (320, FIG. 2), and the data mapping method as applied by the data mapper, (330, FIG. 2).

The change of the data protecting and mapping method is used to secure the protected data stored in the data repository (350, FIG. 2). The change of the data protecting and mapping methods will be initiated in response to detecting that either the interpretation map generated by the data mapper and/or the ids mapping table, has been compromised, for example, once a hacker has obtained an access to the ids mapping table and/or to the interpretation map.

The examples described in FIGS. 3 and 4, assume that “John Doe” has been hashed to “140ec146d14842588a1ee83e14113e66”, and that “140ec146d14842588a1ee83e14113e66” has been mapped to identifier No. 1. In the data repository (350, FIG. 2), identifier No. 1 was stored instead of storing the string “John Doe” or its equivalent “140ec146d14842588a1ee83e14113e66”. In case that an attacker obtains an access to the interpretation map and/or to the ids mapping table, he would easily be able to interpret that identifier No. 1 is the equivalent of “John Doe”.

In order to improve the protection strength of the data stored, the process to which FIG. 5 refers, may be performed proactively as a precaution on a per period of time basis, e.g. once a day. In addition, a further precaution may be adopted by which the interpretation map and the ids mapping table are stored in different locations, preferably with different access permissions. For example, the interpretation map may be stored in an enterprise data center, and the ids mapping table in the cloud, making the system less vulnerable to attacks.

Let us revert now to the method exemplified in FIG. 5. In step 610, a new hash mapping is initiated as a new data protecting method. It can be done in any one of a number of ways, for example by using a different hashing algorithm, or by adding salt where “adding salt” is a cryptographic method that concatenates fix or random data to pieces of information before hashing them. For example, the new data protecting method may apply RIPE Message Digest 128-bit hash function using the string “123” as fix salt.

Returning to the “John Doe” example that was originally mapped to 140ec146d14842588a1ee83e14113e66, it will now be mapped by applying the new data protection method, the hash function to the original string concatenated to the salt element, “John Doe123”, to a7dd03e023f6f590013638eee5e1a639.

By applying this method to all elements that are stored at the interpretation map storage (425, FIG. 3), that may be used by the data protecting module (420, FIG. 3), a new table will be generated, one that includes a mapping between the old hash values and the new ones. The term “protecting mapping table” will be used herein to denote this table.

Now, continuing with the example provided in FIG. 3, the protecting mapping table will include the following pairs:

140ec146d14842588a1ee83e14113e66 will be mapped to: a7dd03e023f6f590013638eee5e1a639
e65de229fa01a8a72e144c2010a8db46 will be mapped to: 7a66549a02cadd17e960680ee1a9be7f
3092575f6d9757b82a5832d8545be4a will be mapped to: 64d0e89cabafb61918d6e37d2c0bd96f
1b04848e5076377f6d65498caf91bd5b will be mapped to: d420a83e59955ca0f5d8c7c42f5c8982
84791b4ecfd07fece21d5126b7eabf5b will be mapped to: d207aaa07a77281583c5dd3938421145

In step 620, data protecting module(s) (330, FIG. 2) will be updated by information associated with the new data protecting method that will be applied, in our example, the data protecting module are updated so that they use RIPE Message Digest 128-bit hash function while using the string “123” as fix salt.

Next, the of the data mappers, (330 and 340, FIG. 2) are updated (step 630) based on the new protection mapping table. In our example the original mapping was

140ec146d14842588a1ee83e14113e66—1
e65de229fa01a8a72e144c2010a8db46—2
3092575f6d97570b82a5832d8545be4a—3
1b04848e5076377f6d65498caf91bd5b—4
84791b4ecfd07fece21d5126b7eabf5b—5,

and the resulting ids mapping table updated in step 630 will be

a7dd03e023f6f590013638eee5e1a639—1
7a66549a02cadd17e960680ee1a9be7f—2
64d0e89cabafb61918d6e37d2c0bd96f—3
d420a83e59955ca0f5d8c7c42f5c8982—4
d207aaa07a77281583c5dd3938421145—5

In step 640 the old interpretation maps, the old ids maps, and the protection mapping table, are erased. In this step the erasing can be affected on part or all of these maps and table. Optionally, step 640 may further comprise sending a request to the different components of the system, e.g. data protecting modules, data interpreting modules, data mappers, and data repository, to erase the above information.

In different embodiments different methods can be used to coordinate the processes of updating the data protecting module with the new data protecting method that they should apply, and for the process of updating the ids mapping table with the information of protecting mapping table, and the process of erasing old mapping information. These methods may include synchronization mechanisms, and mechanisms for handling cases in which not all of the data mappers or all of the data protecting modules are properly updated, or cases where occasionally there is only a partial update of the above entities. These methods should be understood to be encompassed by the present invention.

It is to be understood that the above description only includes some embodiments of the invention and serves for its illustration. Numerous other ways of carrying out the methods provided by the present invention or the use of different parameters, may be devised by a person skilled in the art without departing from the scope of the invention, and are thus encompassed by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for storing received data in a protected mode at a data repository, wherein said system is characterized in that it is configured to prevent interpretation of the protected data in a case where an interpretation map and/or an ids mapping table associated with said protected data is compromised, by changing mode of protection of said protected data, and wherein the change of protection mode of the protected data is affected either upon a) detecting that said interpretation map and/or an ids mapping table has been compromised, or b) on a periodical basis, or c) any combination thereof.

2. The system of claim 1, wherein said system comprising:
at least one processor configured to:
receive data to be protected and apply a first protecting scheme thereon, thereby converting the received data to a protected data;
map the protected data into one or more identifiers; and
initiate a change of said first protecting scheme to a second protecting scheme either a) upon detecting that either said interpretation map and/or said ids mapping table has been compromised, or b) on a periodical basis, or c) any combination thereof, by converting the protected data into the originally received data and applying said second protecting scheme onto said originally received data to obtain a newly protected data;
map the newly protected data into one or more identifiers;
at least one storage configured to:
store information that relates to mapping of the protected data into said one or more identifiers; and
store the one or more identifiers.

3. The system of claim 1, wherein said at least one processor is further configured to map values associated with the first protecting scheme into values associated with the second protecting scheme.

4. The system of claim 1, wherein said system is a distributed system comprising a plurality of processors, wherein at least two of said plurality of processors are located at different geographical locations.

5. The system of claim 4, wherein said system comprises a plurality of storages, wherein at least two of said plurality of storages are located at different geographical locations.

6. The system of claim 1, wherein said data repository comprises both data received in its original form and data received in its protected mode.

7. A method for storing protected data in a data repository, wherein said method is characterized in that it is configured to prevent interpretation of the protected data in case an interpretation map associated with said protected data is compromised, by changing a mode of protection of said protected data, and wherein the change of protection mode of the protected data is affected either upon a) detecting that said interpretation map and/or an ids mapping table has been compromised, or b) on a periodical basis, or c) any combination thereof.

8. The method of claim 7, wherein said method comprises the steps of:
providing data to be protected and applying a first protecting scheme on at least part of the received, thereby converting the at least part of the received data to a protected data;
mapping the protected data into one or more identifiers;
generating an interpretation map which comprises information required to interpret protected data;
generating an ids mapping table which comprises information required to carry out a mapping process of protected data to the respective one or more identifiers, and/or to carry out de-mapping process of said one or more identifiers to respective protected data;
storing said interpretation map and said ids mapping table;
initiating a change of said first protecting scheme with a second protecting scheme, either a) upon detecting that either said interpretation map and/or said ids mapping table has been compromised, or b) on a periodical basis, or c) any combination thereof, by converting the protected data being in its first protected scheme into the originally received data, and applying said second protecting scheme onto said originally received data to obtain a newly protected data;
mapping the newly protected data into one or more identifiers;
storing the one or more identifiers associated with the newly protected data.

9. The method of claim 7, further comprising a step of mapping values associated with the first protecting scheme into values associated with the second protecting scheme.
